(19) United States
(12) Patent Application Publication
(10) Pub. No.: US 2021/0072372 A1
(43) Pub. Date: Mar. 11, 2021

(54) RADAR FRONT END DEVICE WITH CHAINING SUPPORT

(71) Applicant: SEMICONDUCTOR COMPONENTS INDUSTRIES, LLC, Phoenix, AZ (US)

(72) Inventor: Marko MLINAR, Horjul (SI)

(73) Assignee: SEMICONDUCTOR COMPONENTS INDUSTRIES, LLC, Phoenix, AZ (US)

(21) Appl. No.: 16/662,495

(22) Filed: Oct. 24, 2019

Related U.S. Application Data
(60) Provisional application No. 62/898,233, filed on Sep. 10, 2019.

(51) Int. Cl. G01S 13/536; G01S 7/35

(52) U.S. Cl. CPC G01S 13/536; G01S 13/931; G01S 2007/356; G01S 7/354

(57) ABSTRACT

Radar front end devices are provided with data processing and communication architectures that support a daisy-chain configuration. In an illustrative radar system embodiment, each front end device in a set of multiple front end devices includes: processing logic and interface logic. The processing logic is configurable to derive range and velocity data from radar return data. The interface logic is configurable to combine the range and velocity data from the processing logic with range and velocity data from any upstream front end devices in said set and to send the combined range and velocity data to a downstream destination.

### CROSS-REFERENCE TO RELATED APPLICATION

This application claims the benefit of U.S. Provisional Patent Application No. 62/898,233, filed on Sep. 10 2019, the entire contents of which is incorporated herein by reference.

### BACKGROUND

In the quest for ever-safer and more convenient transportation options, many car manufacturers are developing self-driving cars which require an impressive number and variety of sensors. Among the contemplated sensing technologies are multi-input, multi-output radar systems to monitor the distances between the car and any vehicles or obstacles along the travel path. Such systems may employ beam-steering techniques to improve their measurement range and resolution.

Though a single integrated circuit substrate can implement a radar front end device that includes multiple transceivers, the number of transceivers that can be supported by a single substrate may be limited by each transceiver's power consumption and heat dissipation requirements. Thus as the number of antenna elements increases, it becomes desirable to employ multiple front end devices to send and receive radar signals. Existing techniques for conveying measurement data from the multiple front end devices to an electronic control unit (ECU) are undesirably inefficient and/or costly.

### SUMMARY

The problems identified above may be addressed at least in part by radar front end devices having data processing and communication architectures that support a daisy-chain configuration. In an illustrative radar system embodiment, each front end device in a set of multiple front end devices includes: processing logic and interface logic. The processing logic is configurable to derive range and velocity data from radar return data. The interface logic is configurable to combine the range and velocity data from the processing logic with range and velocity data from any upstream front end devices in said set and to send the combined range and velocity data to a downstream destination.

An illustrative front end device embodiment includes processing logic to derive range and velocity data from radar return data; and interface logic to combine the range and velocity data from said processing logic with range and velocity data from any upstream front end devices when sending range and velocity data to a downstream destination.

An illustrative method embodiment for manufacturing a radar front end device includes manufacturing an integrated circuit chip with: a signal generator, a transmitter, at least one receiver, processing logic, and interface logic. The signal generator generates frequency modulated continuous wave (FMCW) radar transmit signals. The at least one receiver converts radar receive signals into radar return data. The processing logic implements a range Fast Fourier Transform (FFT) and a velocity FFT on the radar return data to obtain range and velocity data. The interface logic combines the range and velocity data from said processing logic with range and velocity data from any upstream front end devices for sending combined range and velocity data to a downstream destination.

Each of the foregoing embodiments can be employed individually or in conjunction, and may include one or more of the following features in any suitable combination: 1. a target detector. 2. target detector is a constant false alarm rate (CFAR) detector. 3. the CFAR detector omits range and velocity values below an adaptive threshold. 4. the CFAR detector operates on the range and velocity data from said processing logic to isolate target energy from noise energy before the interface logic performs said combining. 5. the downstream destination is an electronic control unit (ECU) or another front end device. 6. the CFAR detector operates on the combined range and velocity data. 7. the interface logic bypasses the CFAR detector. 8. a signal generator to generate radar transmit signals. 9. at least one receiver to provide the radar return data. 10. the radar transmit signals are frequency modulated continuous wave (FMCW) signals. 11. the processing logic implements a range Fast Fourier Transform (FFT) on the radar return data and a velocity FFT on an output of the range FFT.

### BRIEF DESCRIPTION OF THE DRAWINGS

FIG. 1 is an overhead view of an illustrative vehicle equipped with sensors.

FIG. 2A is a block diagram of a first illustrative driver-assistance system.

FIG. 2B is a block diagram of a second illustrative driver-assistance system.

FIG. 3 is a block diagram of an illustrative radar front end device.

FIG. 4A is a first data cube representing a set of radar measurements.

FIG. 4B is a second data cube representing the set of radar measurements.

FIG. 5A is a data flow diagram for a first illustrative front end device.

FIG. 5B is a data flow diagram for a second illustrative front end device.

FIG. 5C is a data flow diagram for a third illustrative front end device.

FIG. 6 is a data flow diagram for an illustrative radar system.

### DETAILED DESCRIPTION

It should be understood that the following description and accompanying drawings are provided for explanatory purposes, not to limit the disclosure. That is, they provide the foundation for one of ordinary skill in the art to understand all modifications, equivalents, and alternatives falling within the scope of the claims. More specifically, though the following description uses vehicles as an illustrative usage context, the disclosed principles and techniques are applicable to other usage contexts such as traffic monitoring, heart rate monitoring, parking spot occupancy detection, and distance measurement.

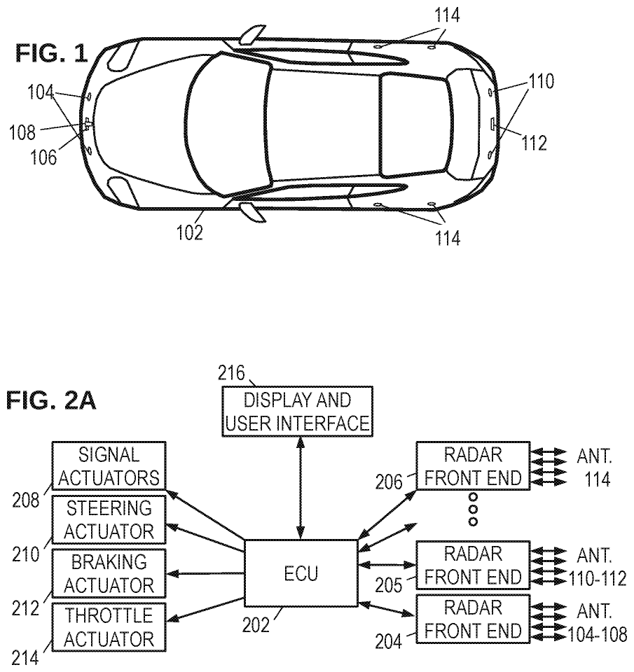

FIG. 1 shows an illustrative vehicle 102 equipped with an array of radar antennas, including antennas 104 for short range sensing (e.g., for park assist), antennas 106 for mid-range sensing (e.g., for monitoring stop & go traffic and cut-in events), antennas 108 for long range sensing (e.g., for adaptive cruise control and collision warning), each of which may be placed behind the front bumper cover. Antennas 110 for short range sensing (e.g., for back-up assist) and antennas 112 for mid range sensing (e.g., for rear collision warning) may be placed behind the back bumper cover. Antennas 114 for short range sensing (e.g., for blind spot monitoring and side obstacle detection) may be placed behind the car fenders. Each set of antennas may perform multiple-input multiple-output (MIMO) radar sensing. The type, number, and configuration of sensors in the sensor arrangement for vehicles having driver-assist and self-driving features varies. The vehicle may employ the sensor arrangement for detecting and measuring distances/directions to objects in the various detection zones to enable the vehicle to navigate while avoiding other vehicles and obstacles.

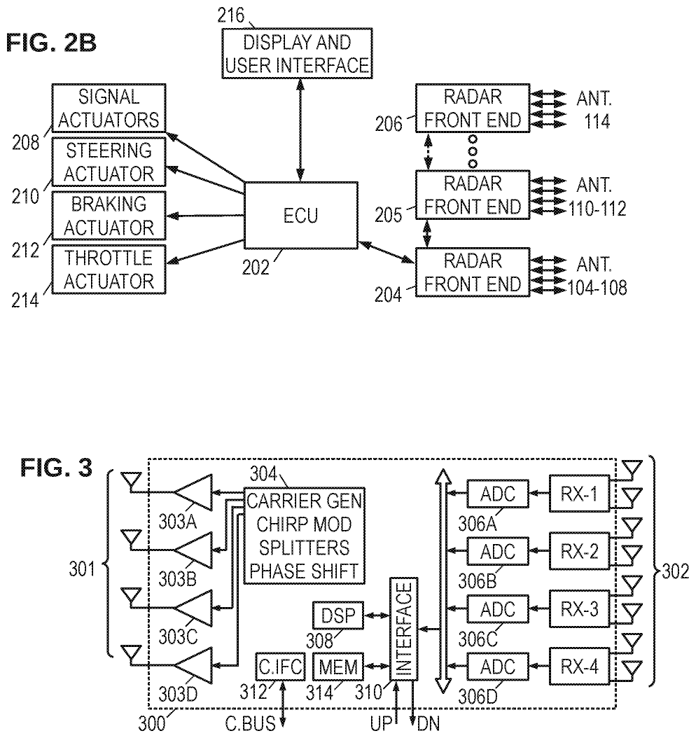

FIG. 2A shows an electronic control unit (ECU) 202 coupled to the various radar front end devices 204-206 as the center of a star topology. The radar front ends each include mm-wave frequency transceivers which couple to some of the transmit and receive antennas 104-114 to transmit electromagnetic waves, receive reflections, and optionally to perform processing for determining a spatial relationship of the vehicle to its surroundings. (Such processing may alternatively be performed by the ECU 202.) To provide automated parking assistance, the ECU 202 may further connect to a set of actuators such as a turn-signal actuator 208, a steering actuator 210, a braking actuator 212, and throttle actuator 214. ECU 202 may further couple to a user-interactive interface 216 to accept user input and provide a display of the various measurements and system status.

Using the interface, sensors, and actuators, ECU 202 may provide automated parking, assisted parking, lane-change assistance, obstacle and blind-spot detection, autonomous driving, and other desirable features. In an automobile, the various sensor measurements are acquired by one or more electronic control units (ECU), and may be used by the ECU to determine the automobile's status. The ECU may further act on the status and incoming information to actuate various signaling and control transducers to adjust and maintain the automobile's operation. Among the operations that may be provided by the ECU are various driver-assist features including automatic parking, lane following, automatic braking, and self-driving.

To gather the necessary measurements, the ECU may employ a MIMO radar system. Radar systems operate by emitting electromagnetic waves which travel outward from the transmit antenna before being reflected back to a receive antenna. The reflector can be any moderately reflective object in the path of the emitted electromagnetic waves. By measuring the travel time of the electromagnetic waves from the transmit antenna to the reflector and back to the receive antenna, the radar system can determine the distance to the reflector. If multiple transmit or receive antennas are used, or if multiple measurements are made at different positions, the radar system can determine the direction to the reflector and hence track the location of the reflector relative to the vehicle. With more sophisticated processing, multiple reflectors can be tracked. At least some radar systems employ array processing to “scan” a directional beam of electromagnetic waves and construct an image of the vehicle's surroundings. Both pulsed and continuous-wave implementations of radar systems can be implemented, though frequency modulated continuous wave radar systems are generally preferred for accuracy.

The star topology of FIG. 2A has a drawback in that the ECU must somehow support a large number of direct-connect sensor buses. One proposed way to alleviate this drawback is to employ a separate hub device or bus bridge that intermediates between all of the front end device communication buses and a single direct-connect bus to the ECU. However, the requirement for an additional integrated circuit device is believed to be undesirable.

Accordingly, FIG. 2B shows a preferred topology in which multiple radar front end devices are daisy-chained together, enabling communication via a single direct-connect bus of the ECU without requiring a separate bridge device. (Though shown as a single bi-directional bus, the use of two unidirectional buses is also contemplated. A command bus may convey commands from the ECU to the front end devices, and a data bus may convey data from the front end devices to the ECU.) In at least some contemplated implementations, the front end device 204 connects to the ECU via a MIPI (Mobile Industry Processor Interface) Alliance A-Phy bus, which supports four lanes of high data rate (10 Gbps to 48 Gbps) transfer over a distance of at least 15 meters. Short range communication buses may be employed for data transfer between front end devices. Each of the front end devices 204-206 preferably contain the same internal components, though some of those components may be disabled as discussed further below. The cost associated with such “dark silicon” is expected to be far less than the cost of a separate bridge device.

FIG. 3 shows a block diagram of an illustrative front end device 300 for a radar system (e.g. as devices 204-206 of FIGS. 2A-2B). Device 300 may be implemented as an integrated circuit on a semiconductor substrate, singulated to form a “chip” and packaged in a standard fashion for mounting on a printed circuit board having traces that connect the device to the antenna elements. Device 300 has antenna feeds or terminals for coupling to an array of transmit antennas 301 and receive antennas 302. Adjustable gain amplifiers 303A-303D drive the transmit antennas 301 with amplified signals from transmitter circuitry 304. Circuitry 304 generates a carrier signal within a programmable frequency band, using a programmable chirp rate and range. The signal generator may employ a voltage controlled oscillator with suitable frequency multipliers. Splitters and phase shifters derive the transmit signals for the multiple transmitters TX-1 through TX-4 to operate concurrently, and further provide a reference “local oscillator” signal to the receivers for use in the down-conversion process. In the illustrated example, front end device 300 includes 4 transmitters (TX-1 through TX-4) each of which is fixedly coupled to a corresponding transmit antenna 301. In alternative embodiments, multiple transmit antennas are selectably coupled to each of the transmitters.

Front end device 300 further includes 4 receivers (RX-1 through RX-4) each of which is selectably coupled to two of the receive antennas 302, providing a reconfigurable MIMO system with 8 receive antennas, four of which can be employed concurrently to collect measurements. Four analog to digital converters (ADCs) 306A-306D sample and digitize the down-converted receive signals from the receivers RX-1 through RX-4, supplying the digitized signals to processing logic 308 (such as a digital signal processor (DSP)) for filtering and processing, or directly to interface logic 310 to enable off-chip processing of the digitized baseband signals. Interface logic 310 may take the form of a routing switch or other standard implementation of bridge between the external buses, the internal data bus, and the processor/memory bus.

A control interface 312 enables the ECU or other host processor to configure the operation of each front end device 300, including the transmit signal generation circuitry 304, processing logic 308, and interface logic 310. On-board memory 314 enables the processing logic 308 and/or interface logic 310 to buffer the digitized signals and any derived target measurement data in accordance with the configuration parameters set via the control interface.

As discussed further below, the processing logic 308 may operate on the digitized receive signals to derive target range data, derive target velocity data, derive target angle-of-approach data, and/or to screen out various forms of noise such as interference and clutter. The screening operation can alternatively be viewed as tentative target identification or separation of target energy from noise energy. Though some radar systems perform such processing in a central location (e.g., the ECU), the contemplated systems apportion at least some of the processing among the front end devices 204-206.

Before describing the contemplated data flows for the front end devices and resultant incorporation of daisy-chaining support, it is helpful to understand the processing that the radar systems may employ to derive target information from digitized signal measurements.

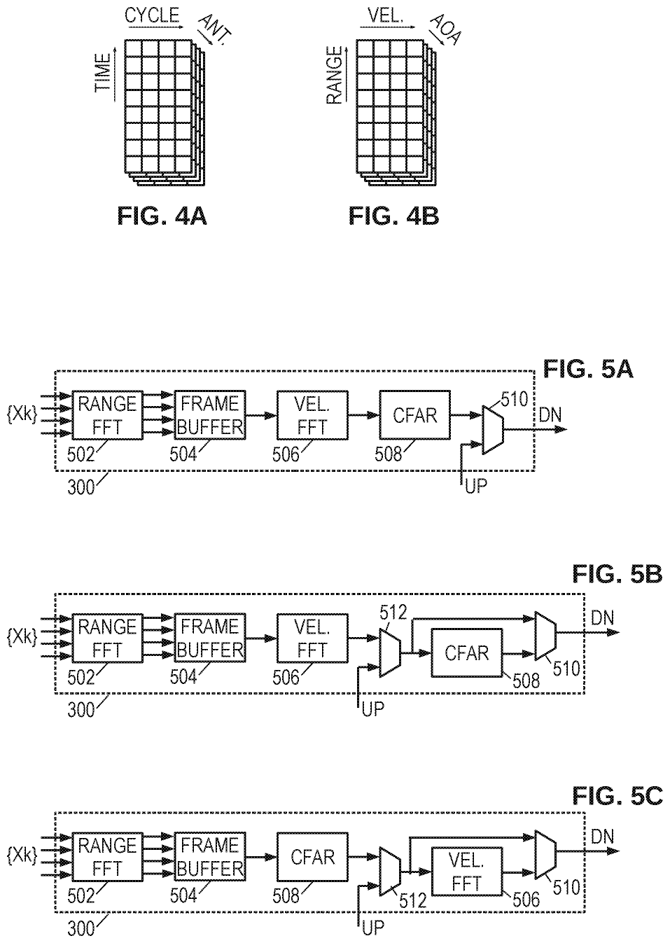

FIG. 4A shows an illustrative data cube representing a portion of the digital signal measurements that may be collected by a given front end device using chirp modulated continuous wave signal transmission. Each chirp (one-way traversal of the frequency range) may be considered as a measurement cycle. During a measurement cycle, the front end digitizes the down-converted receive signals from the selected receive antennas, thereby providing a time-sequence of digitized receive signal samples. Due to the chirp modulation, the signal energy reflected by the targets reaches the receive antennas with a frequency offset that depends on the round-trip travel time (and hence on the distance to the target). A Fast Fourier Transform (FFT) of the time sequence collected in a given cycle will isolate the energy associated with each frequency offset, yielding a function of reflected energy versus target range. This operation, which may be referred to herein as the “range FFT”, may be performed for each antenna in each measurement cycle. The range FFT yields peaks for each target having a given range.

Motion of the target relative to the antenna array adds a Doppler shift to the reflected signal energy, the Doppler shift being essentially proportional to the relative velocity. Though it is usually small relative to the range-induced frequency offset, it is nevertheless observable as a change in the phase of the associated frequency coefficients in subsequent measurement cycles. (Recall that FFT coefficients are complex-valued, having both magnitude and phase.) Applying an FFT to the corresponding frequency coefficients in a sequence of measurement cycles will isolate the energy associated with each relative velocity, yielding a function of reflected energy versus target velocity. This operation, which may be referred to herein as the “velocity FFT”, may be performed for each range and each antenna. The resulting two-dimensional data array possesses “peaks” for each target having a given range and relative velocity.

The reflected energy from a given target reaches the individual receive antennas in the antenna array with a phase that depends on the direction of arrival of the reflected energy (aka “angle of approach”). Applying an FFT to corresponding frequency coefficients associated with a sequence of uniformly spaced antennas will isolate the energy associated with each incidence angle, yielding a function of reflected energy versus angle of approach (“AoA”). This operation, which may be referred to herein as the “AoA FFT”, may be performed for each range and velocity.

Thus, digitized signal measurements arranged in a measurement data cube having its three dimensions representing functions of time, measurement cycle, and antenna position (as shown in FIG. 4A), can be transformed into a target data cube having its three dimensions representing functions of range, velocity, and AoA (as shown in FIG. 4B). As FFTs are linear, the range FFT, velocity FFT, and AoA FFT can be performed in any order. Further, the FFT operations are independent (meaning that, e.g., the range FFT for a given antenna and cycle is independent of the range FFTs for other antennas and other cycles, and the velocity FFT for a given range and antenna is independent of the velocity FFTs for other ranges and antennas) enabling the FFT processing to be readily apportioned among multiple front end devices and the results merely concatenated.

Another desirable processing operation is the separation of signal energy from noise energy. Any suitable noise suppression or target detection technique may be used. One popular technique (which includes many variants) is that of constant false alarm rate (CFAR) detection. CFAR detection employs detection threshold adaptation based on measurement energy values in a sliding window near or around the measurement being evaluated (aka “cell under test”). The original technique and its variations offer various tradeoffs between performance and computational complexity by using different statistical approaches to deriving the detection threshold from the measurements within the sliding window. CFAR detection is a non-linear technique because the measurements values below the threshold are zeroed or ignored, but its position in the processing sequence may nevertheless be modified because the zeroing of frequency coefficients generally will not prevent subsequent FFTs from exploiting the relevant phase/frequency information of energy peaks representing targets.

FIG. 5A shows an illustrative data flow that may be implemented by each front end device 300. The processing logic 308 may perform range FFTs on the digitized receive signals xₖ from each antenna essentially as the signals are acquired, storing the resulting frequency coefficients as range data in a frame buffer 504 in memory 314. The frame buffer 504 accumulates range data from multiple measurement cycles, enabling the processing logic 308 to perform velocity FFTs 506 to produce target range and velocity data for each antenna as discussed previously. A CFAR detector 508 operates on the target range and velocity data to remove noise energy below the adaptive threshold. The CFAR detector 508 may zero the below-threshold values, leaving only the above-threshold values as representing range and velocity of potential targets (radar energy reflectors). In certain contemplated variations, the CFAR detection process compresses the volume of data by omitting at least some of the below-threshold values, and by perhaps employing a more sophisticated data compression technique. The interface logic 310 may combine the target range and velocity data from the on-board processing logic 308 with target range and velocity data received from upstream (“UP”) front end devices 300 and send the combined data to a downstream (“DN”) destination. The downstream destination may be another front end device, or it may be the ECU. In the illustrated data flow, the interface logic 310 concatenates the locally-generated data to the upstream data, operating as a multiplexer 510.

FIG. 5B shows a preferred data flow that may be implemented by each front end device 300. As before, the processing logic 308 may implement range FFT 502 and velocity FFT 506, using memory 314 as a frame buffer 504. In all but the last front end device 300 (the device that directly connects to the ECU), the CFAR detector 508 is bypassed. Instead, the interface logic 310 implements a multiplexer 512 to concatenate the locally-generated range and velocity data to range and velocity data from upstream front ends, and a second multiplexer 510 that bypasses the CFAR detector 508. In the last front end device, the second multiplexer 510 sends the output of the CFAR detector 508 to the ECU. The processing logic 308 implementing the CFAR detector is thus able to adapt the threshold based on measurements from all antennas rather than just those connected locally to the front end device, yielding an improved performance.

FIG. 5C shows yet another illustrative data flow that may be implemented by each front end device 300. As before, the processing logic 308 may perform range FFTs on the digitized receive signals xₖ from each antenna essentially as the signals are acquired, storing the resulting frequency coefficients as range data in a frame buffer 504 in memory 314. The frame buffer 504 accumulates range data from multiple measurement cycles. A CFAR detector 508 passes only those ranges from exceeding the adaptive threshold, reducing the volume of data requiring subsequent transport and processing. The interface logic 310 implements a multiplexer 512 to concatenate the target range data from the processing logic 308 with the target range data received from upstream front ends, and a multiplexer 510 that optionally bypasses the velocity FFT 506 when sending data to a downstream destination. In the last front end device (the one directly connected to the ECU), the processing logic 308 performs the velocity FFT on the range data, producing the target range and velocity data for the ECU.

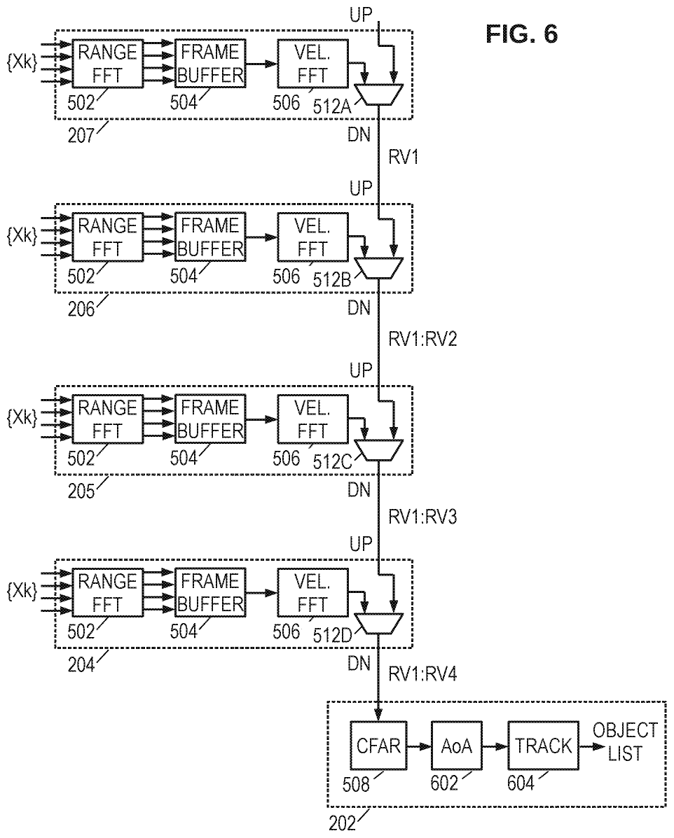

FIG. 6 is a data flow diagram for an illustrative implementation of FIG. 2B, in which the radar front end devices 204-207 each derive range and velocity data from the radar return data they receive from their connected antennas. The upstream connection of front end device 207 is unconnected, so multiplexer 512A simply passes the locally derived range and velocity data (RV1) for each measurement frame to the upstream connection of front end device 206. For each measurement frame, multiplexer 512B provides the downstream front end device 205 with a concatenation of the locally derived range and velocity data (RV2) with the range and velocity data from the upstream connection. Similarly, multiplexer 512C provides downstream front end device 204 with a concatenation of the locally derived range and velocity data (RV3) with the range and velocity data from its upstream connection. The last front end device 204 provides the ECU 202 with a concatenation of the locally derived range and velocity data (RV4) concatenated with the range and velocity data from all the other front end devices 205-207.

In the illustrated embodiment, ECU 202 performs CFAR detection 508 on the full frame of range and velocity data, before conducting an AoA FFT 602 to further characterize each target. ECU 202 further performs target tracking 604, enabling multiple measurement frames to be used in a fashion that improves system performance. The resulting list of targets (“object list”) can then be employed by the ECU 202 to provide automated driving or various driver assist features. As previously mentioned, the disclosed principles are not limited to this usage context, but can be readily adapted for other radar system applications.

Numerous other modifications, equivalents, and alternatives, will become apparent to those of ordinary skill in the art once the above disclosure is fully appreciated. For example, the FFTs may be bypassed or omitted such that the digitized measurements are communicated to the ECU for central processing. It is intended that the following claims be interpreted to embrace all such modifications, equivalents, and alternatives where applicable.

What is claimed is:

1. A radar system that comprises a set of integrated circuit chips, each chip including:
processing logic to derive range and velocity data from radar return data; and
interface logic to combine the range and velocity data from said processing logic with range and velocity data from any upstream chips in said set when sending range and velocity data to a downstream destination.

2. The radar system of claim 1, wherein each chip further comprises a target detector.

3. The radar system of claim 2, wherein said target detector is a constant false alarm rate (CFAR) detector.

4. The radar system of claim 3, wherein the CFAR detector omits range and velocity values below an adaptive threshold.

5. The radar system of claim 3, wherein the CFAR detector operates on the range and velocity data from said processing logic to isolate target energy from noise energy before the interface logic performs said combining.

6. The radar system of claim 3, wherein the set of integrated circuit chips includes a last integrated circuit chip coupled to an electronic control unit (ECU) and one or more upstream integrated circuit chips coupled to the last integrated circuit chip, wherein the CFAR detector in the last integrated circuit chip operates on the combined range and velocity data.

7. The radar system of claim 6, wherein the interface logic in the one or more upstream integrated circuit chips bypasses the CFAR detector.

8. The radar system of claim 1, wherein each chip further includes a signal generator to generate radar transmit signals and at least one receiver to provide the radar return data.

9. The radar system of claim 8, wherein the radar transmit signals are frequency modulated continuous wave (FMCW) signals, and wherein the processing logic implements a range Fast Fourier Transform (FFT) on the radar return data and a velocity FFT on an output of the range FFT.

10. A radar front end device that comprises an integrated circuit chip having:
processing logic to derive range and velocity data from radar return data; and
interface logic to combine the range and velocity data from said processing logic with range and velocity data from any upstream front end devices when sending range and velocity data to a downstream destination.

11. The device claim 10, further comprising a target detector.

12. The device of claim 11, wherein said target detector is a constant false alarm rate (CFAR) detector.

13. The device of claim 12, wherein the CFAR detector omits range and velocity values below an adaptive threshold.

14. The device of claim 12, wherein the CFAR detector operates on the range and velocity data from said processing logic to isolate target energy from noise energy before the interface logic performs said combining.

15. The device of claim 12, wherein the downstream destination is an electronic control unit (ECU), and wherein the CFAR detector operates on the combined range and velocity data.

16. The device of claim 12, wherein the downstream destination is another front end device, and wherein interface logic bypasses the CFAR detector.

17. The device of claim 10, further comprising a signal generator to generate radar transmit signals and at least one receiver to provide the radar return data.

18. The device of claim 17, wherein the radar transmit signals are frequency modulated continuous wave (FMCW) signals, and wherein the processing logic implements a range Fast Fourier Transform (FFT) on the radar return data and a velocity FFT on an output of the range FFT.

19. A method of manufacturing a radar front end device, the method comprising manufacturing an integrated circuit chip with:
a signal generator to generate frequency modulated continuous wave (FMCW) radar transmit signals;
at least one receiver to convert radar receive signals into radar return data;
processing logic to implement a range Fast Fourier Transform (FFT) and a velocity FFT on the radar return data to obtain range and velocity data; and
interface logic to combine the range and velocity data from said processing logic with range and velocity data from any upstream front end devices for sending combined range and velocity data to a downstream destination.

20. The method of claim 19, further comprising providing a constant false alarm rate (CFAR) detector to operate on the range and velocity data to isolate target energy from noise energy.
